(19) United States
(12) Patent Application Publication
(10) Pub. No.: US 2016/0096195 A1
(43) Pub. Date: Apr. 7, 2016

(54) BEAD-COATED SHEET

(71) Applicant: 3M INNOVATIVE PROPERTIES COMPANY, Saint Paul, MN (US)

(72) Inventors: Amy S. Barnes, St. Paul, MN (US); John C. Clark, Maplewood, MN (US); Vivek Krishnan, St. Paul, MN (US); Anatoly Z. Rosenflanz, Maplewood, MN (US); Steven D. Theiss, Woodbury, MN (US)

(21) Appl. No.: 14/892,054

(22) PCT Filed: May 21, 2014
(86) PCT No.: PCT/US14/38919

§ 371 Date: Nov. 18, 2015

Related U.S. Application Data
(60) Provisional application No. 61/827,160, filed on May 24, 2013.

(51) Int. Cl. B05D 5/08; B05D 3/12; C23C 26/00; B05D 1/36

(52) U.S. Cl. CPC B05D 5/08; B05D 1/36; B05D 3/12; C23C 26/00

(57) ABSTRACT

Described herein is a bead-coated sheet and methods of making wherein a sheet substrate selected from a metal, a glass, and/or a glass-ceramic, comprises a layer of microspheres that are partially embedded into the surface of the sheet substrate such that a portion of each of the microspheres projects outwardly from the surface of the sheet substrate.

### TECHNICAL FIELD

This disclosure relates to a sheet substrate comprising metal, glass-ceramic, and/or glass, wherein the surface of the sheet substrate comprises a partially embedded layer of microspheres.

### DESCRIPTION OF THE FIGURES

FIG. 1A is a cross-sectional view of a bead-coated sheet according to one embodiment of the present disclosure;

FIG. 1B is a cross-sectional view of a bead-coated sheet according to one embodiment of the present disclosure;

FIG. 2 is a cross-sectional view of a bead-coated sheet according to one embodiment of the present disclosure;

FIG. 3 is a cross-sectional view of bead-coated sheet 30 in contact with platen 38, according to one embodiment of the present disclosure;

FIG. 4 is a cross-sectional view of bead-coated sheet 40 according to one embodiment of the present disclosure;

FIG. 5A is an optical micrographs of Comparative Example A;

FIGS. 5B-5D are optical micrographs of Example 1;

FIG. 5E is an optical micrographs of Example 2

FIG. 6 is an optical micrograph of Example 3; and

FIG. 7 is a figure of the Coefficient of Friction versus Normal Force for Example 1 and Comparative Example D.

### SUMMARY

The present disclosure is directed towards providing metal, glass-ceramic, and/or glass substrates with a durable and/or low friction surface.

In one embodiment, a bead-coated sheet is provided comprising: a sheet substrate selected from at least one of: a metal, a glass, and a glass-ceramic; and a layer of microspheres, wherein the microspheres are partially embedded into a surface of the sheet substrate so that a portion of each of the microspheres projects outwardly from the surface of the sheet substrate, wherein (a) the average diameter of the microsphere is greater than 20 micrometers and/or (b) the microspheres are substantially spherical.

In another embodiment, an article is provided comprising a bead-coated sheet comprising: a sheet substrate selected from at least one of: a metal, a glass, and a glass-ceramic; and a layer of microspheres, wherein the microspheres are partially embedded into a surface of the sheet substrate so that a portion of each of the microspheres projects outwardly from the surface of the sheet substrate, wherein (a) the average diameter of the microsphere is greater than 20 micrometers and/or (b) the microspheres are substantially spherical.

In yet another embodiment, method of making a bead-coated sheet is provided comprising: applying a layer of microspheres onto a sheet substrate, wherein the sheet substrate is selected from at least one of a metal, a glass, a glass-ceramic, and combinations thereof; and embedding the microspheres into the surface of the sheet substrate so that a portion of each of the microspheres projects outwardly from the surface of the sheet substrate, wherein (a) the average diameter of the microsphere is greater than 20 micrometers and/or (b) the microsphere is substantially spherical.

The above summary is not intended to describe each embodiment. The details of one or more embodiments of the invention are also set forth in the description below. Other features, objects, and advantages will be apparent from the description and from the claims.

### Definitions

As used herein, the term

“a”, “an”, and “the” are used interchangeably and mean one or more; and

“and/or” is used to indicate one or both stated cases may occur, for example A and/or B includes, (A and B) and (A or B).

As used herein “glass” refers to amorphous oxide material exhibiting a glass transition temperature; “glass-ceramic” refers to a material formed by heat treatment of a glass to nucleate ceramic crystals in the amorphous matrix, and “ceramic” refers to a crystalline inorganic material that has strong covalent bonds.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

### DETAILED DESCRIPTION

There is a desire to provide a durable, low friction surface for more rigid substrates such as metal, glass-ceramic, and/ or glass. Aluminum and stainless steel, for example, are generally known to scratch. A standard technique to improve the surface hardness of aluminum is to anodize it by growing a film of aluminum oxide onto the surface via electrochemical methods. However, the anodized layer of the aluminum is known to be brittle and the sliding wear properties of the surface are less than satisfactory due to higher friction. Thus, an alternative is desirable.

Hard inorganic particles have been dispersed in metal and metal alloys as a means of reinforcing the metal, such materials may generally be referred to as metal matrix composites. For example, U.S. Pat. No. 5,361,678 (Roopchand et al.) discloses adding ceramic particles to an aluminum alloy to form a composite, and Japanese Pat. Publ. No. S58-153706 (Kiuchi) discloses three different methods for making a composite comprising a dispersed reinforcing particle and a metal.

In the present disclosure, it has been discovered that by partially embedding a layer of microspheres into the surface of a sheet substrate, such that a portion of the microspheres protrude from the surface, a bead-coated sheet with an increased durability (e.g. resistance to scratching) and/or lower surface friction may result.

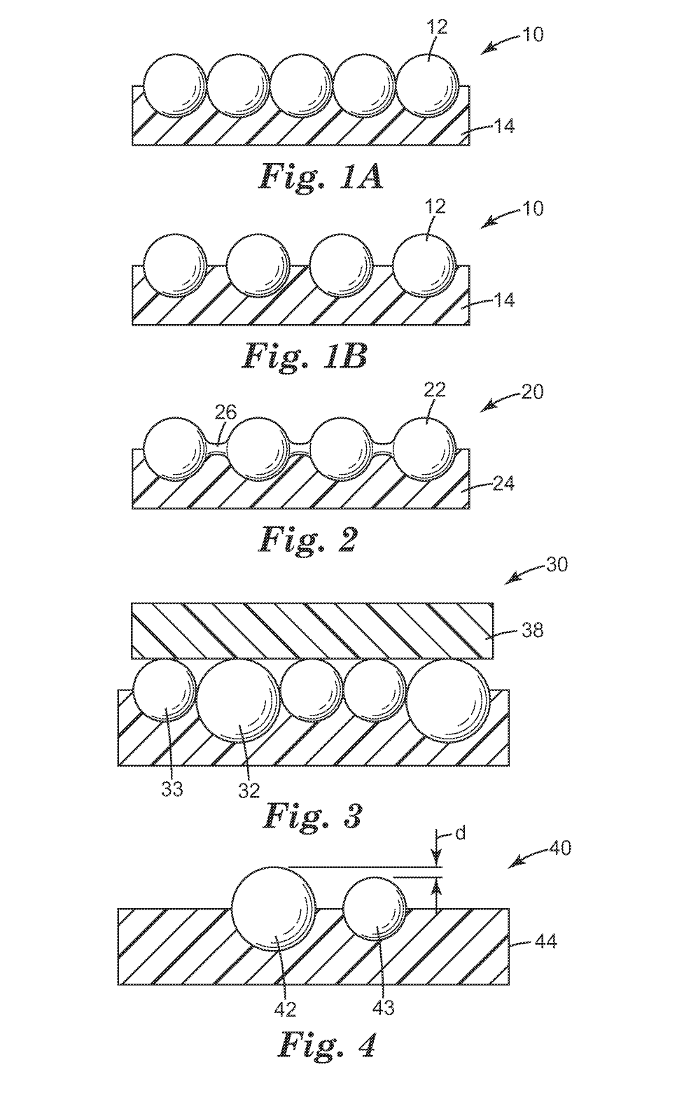

Shown in FIG. 1A is one embodiment of the present disclosure. Bead-coated sheet 10 comprises microspheres 12 embedded into sheet substrate 14.

The substrate sheets of the present disclosure are selected from a metal, a glass, a glass-ceramic, and combinations thereof.

Exemplary metals include: aluminum, copper, tin, nickel, chrome, magnesium, titanium, iron, metal alloys (e.g., stainless steel), and combinations thereof.

Glass refers to amorphous materials composed of primarily of SiO₂, P₂O₅, B₂O₃, Al₂O₃, GeO₂, alkali or alkaline earth modifiers (e.g., Na₂O, K₂O, Li₂O, CaO, MgO), and combinations thereof. In one embodiment, the glass may include other components such as TiO₂, TeO₂, REO (rare earth oxides), ZnO, etc. Exemplary glass includes soda lime silicate glass, borosilicate, S-glass, E-glass, titanate- and aluminate-based glasses, etc.

Glass ceramics refer to polycrystalline materials that are formed through the controlled crystallization of an amorphous material. The crystallization process is typically a secondary heat treatment of the glass under controlled heating and cooling conditions. Exemplary glass-ceramics are lithium silicates, alkaline earth aluminosilicates, alkaline earth aluminates and rare earth aluminates.

In one embodiment, the sheet substrate may comprise combinations of a metal, a glass, and/or a glass-ceramic. For example, a glass substrate may comprise a thin layer of a metal on its major surface, wherein the microspheres on the major surface of the sheet substrate are embedded in both the metal and glass materials. Alternatively, a metal substrate may comprise a thin layer of a glass or glass-ceramic on its major surface, wherein the microspheres on the major surface of the sheet substrate are embedded in both the glass or glass-ceramic and metal materials.

Because the microspheres are embedded into the sheet substrate, the sheet substrate must be sufficiently thick to enable the partial embedding of the microspheres. Generally, the sheet substrate has a thickness of at least 10, 25, 50, 100, or even 250 μm (micrometers) or even more (e.g., at least 1 centimeter, or even 1 meter). The upper limit of the thickness of the sheet substrate is not particularly limited, except by what can reasonably be handled and/or fit in an assembly to do the pressing (e.g., the clearance of the pressing machine, if used).

The microspheres are embedded into the major surface of the sheet substrate to impart beneficial properties to the surface of the sheet substrate, including for example, improved durability and/or lowering the friction of the surface.

The microspheres of the present disclosure can be made from glass, ceramic, glass-ceramic, metal, or combinations thereof.

See the descriptions above for glass, glass-ceramics and metals. Ceramics include for example, silicon oxide, aluminum oxide, tin oxide, zinc oxide, bismuth oxide, titanium oxide, zirconium oxide, lanthanide oxides, mixtures thereof and the like and other metal salts such as calcium carbonate, calcium aluminate, magnesium alminosilicate, potassium titanate, cerium ortho-phosphate, hydrated aluminum silicate, mixtures thereof, and the like.

In one embodiment, the microspheres of the present disclosure are not alumina.

To create improved surface properties, such low friction surfaces and/or smooth-to-the-touch surfaces, the plurality of microspheres should be, among other things, substantially spherical and/or smooth-surfaced.

In one embodiment, of the present disclosure, the microspheres are substantially spherical particles. Sphericity refers to how spherical a particle is. The degree of sphericity of a particle is the ratio of the surface area of a sphere of set volume to the surface area of that particle with the same volume. Substantially spherical means the average degree of sphericity for a plurality of microspheres is at least 0.75, 0.8, 0.85, 0.9, 0.95 or even 0.99, with the theoretical sphericity of 1.0 for a perfect sphere.

Roundness is another term used to describe particles, this term refers to the sharpness of the particle's edges and corners. It is expressed as the ratio of the average radius of the corners veruss the radium of the maximum inscribed circle. A Krumbein and Sloss Chart can be consulted to see the relationship between sphericity and roundness. Typically, the microspheres of the present disclosure have a high degree of roundness, for example, at least 0.6, 0.7, or even 0.9.

In one embodiment, the surface of the microsphere in the plurality of microspheres is substantially smooth. In other words, the plurality of microspheres have an average roughness (_{Ra}) of less than 1, 0.75, 0.5, 0.25, or even 0.1 micrometers. Techniques known in the art can be used to determine the roughness. Typically, a stylus profiler, optical profiler, or scanning probe microscopes is used to profile the surface and the resulting profile is used to calculate the _{Ra} value. Smooth surfaced microspheres are typically made by a melt process, polishing (e.g., flame or mechanical processes), and/or sintering. For example, in a melt process, the beads are typically made by melting the raw materials, and dispersing the melt into individual droplets, which are subsequently cooled. In a sol-gel process, a sol is dripped from an orifice, surface tension spheriodizes the sol, which is then fired and sintered.

In the present disclosure, the microspheres of the present disclosure may be solid core microspheres or hollow core microspheres. Ideally, the microspheres need to be able to withstand the force of the pressing so that the integrity of the microspheres remain intact.

The hardness of the microspheres can be selected depending on sheet substrate selected and the application. In one embodiment, the hardness of the microspheres is greater than that of the sheet substrate. The hardness of a surface can be measured using Vicker's hardness or other such techniques known in the art. For example, soda lime silicate glass typically has Vicker's hardness of 460-500 HV, while commonly used aluminum sheet metal alloys (like 5005 series) have Vicker's hardness of 46 HV. Having the hardness of the microspheres being greater than that of the sheet substrate is especially useful if one is trying to increase the durability of the sheet substrate's surface.

In one embodiment of the present disclosure, the microspheres are uncoated.

In another embodiment of the present disclosure, the microspheres are coated. The microspheres may be coated, for example, to improve the wettability of the microspheres, and/or make the microspheres more compatible with the sheet substrate. In one embodiment, the surface of the microsphere comprises at least one of: a metal, a metal oxide, a flux, a wetting layer, and combinations thereof.

In one embodiment of the present disclosure, the microspheres are preferably free of defects. As used herein, the phrase “free of defects” means that the microspheres have low amounts of undesired bubbles, and/or low amount of inhomogeneities.

The microspheres are typically sized via screen sieves to provide a useful distribution of particle sizes. Sieving is also used to characterize the size of the microspheres. With sieving, a series of screens with controlled sized openings is used and the microspheres passing through the openings are assumed to be equal to or smaller than that opening size. For microspheres, this is true because the cross-sectional diameter of the microsphere is almost always the same no matter how it is oriented to a screen opening. It is desirable to use as broad a size range as possible to control economics and maximize the packing of the microspheres on the surface. However, some applications may require limiting the microsphere size range to provide a more uniform microsphere coated surface.

In some embodiments, a useful range of average microsphere diameters based on volume is at least 5, 10, 20, 25, 30, 35, 40, 50, 75, 100, 150, 200 or even 250 μm; at most 500, 600, 800, 900, or even 1000 μm. The microspheres may have a unimodal or multi-modal (e.g., a bimodal) size distribution depending on the application.

The microspheres useful in the present disclosure may be transparent, translucent (partially transparent), or opaque. In one embodiment, the microspheres have an average refractive index of at least 1.4, 1.6, 1.8, 2.0, 2.2, or even 2.6.

In the present disclosure, the microspheres are partially embedded into the surface of the sheet substrate such the microspheres are embedded enough to create sufficient adhesion between the sheet substrate and the microsphere (so that the microspheres do not easily come off the surface), while not embedded so far that the friction-reduction benefits are not realized. Typically this means that at least 15, 20, 30, 40, or even 50% of the average diameter of each microsphere is embedded in the sheet substrate and at most 70, 80, 85, or even 90% of the average diameter of each microsphere is embedded in the sheet substrate.

A monolayer equivalent (i.e., one layer of microspheres) or less of the microspheres is used on the sheet substrate surface.

In one embodiment, to create a uniform monolayer, either a liquid is applied to the surface of the sheet substrate and then the microspheres are applied to the surface or the microspheres are mixed with a liquid to form a dispersion, which is applied to the surface of the sheet substrate. The liquid enables the microspheres to disperse and form a monolayer on the surface of the sheet substrate. The thin liquid layer helps keep a uniform tightly packed layer of beads in place during sample transfer into the press and may be cleanly removed when subjected to temperature. The liquid should be one that does not evaporate while dispersing the microspheres on the surface of the sheet substrate, such liquids include solvent or a binder.

Typically the solvent is selected to not evaporate during the forming of the microsphere monolayer on the sheet substrate, but is removed during and/or after the embedding of the microspheres. Exemplary solvents include triglycerides (e.g., oleic acid) and diols and polyols (e.g., glycerols and glycols). In one embodiment it is desirable that the solvent does not leave any residue on the resulting bead-coated sheet.

Typically, in bead-coated sheets, monolayers of microspheres are achieved with the use of an adhesive or tacky material that holds the beads. When subjected to high temperature these tacky materials burn and leave a dark residue that is undesired. If one uses a low temperature bead sink procedure, the tacky binder material remains in the system and can potentially affect mechanical properties and adhesion to the support sheet.

Although a binder may be used in one embodiment of the present disclosure, the microspheres of the bead-coated sheet are embedded into the sheet substrate. In other words, the underlying sheet substrate has a surface profile indented by the microspheres.

In some embodiments, the liquid used to form the monolayer of microspheres is removed either during or after embedding the microspheres. The removal is typically via heating to a temperature to cause evaporation or decomposition of the liquid. There may or may not be residue of the liquid remaining.

In another embodiment, a uniform monolayer of microspheres is created by using a screen or patterned tray. In this embodiment, a screen or tray can be placed on top of the sheet substrate and the microspheres flooded onto the surface and the excess removed to create a monolayer of beads and then pressing the beads into the substrate.

FIG. 1B depicts another embodiment of bead-coated sheet 10 comprising microspheres 12 embedded into sheet substrate 14. The monolayer of microspheres of the bead-coated sheet, ideally are closest-packed, such as the space between individual microspheres is less than 5, 4, 2, or even 1 times the diameter of an average microsphere. However, depending on the size distribution of the microspheres and the method of applying them onto the surface of the sheet substrate, something less than closest-packed may result. To achieve the beneficial properties of the partially embedded microspheres, typically at least 50, 60, 70, 80, 90 or even 95% of the surface of the bead-coated sheet is covered with a monolayer of microspheres.

In the present disclosure, the microspheres are at least partially embedded into a surface of the sheet substrate so that a portion of each of the microspheres projects outwardly from the surface of the sheet and the microspheres indent the underlying sheet substrate. In the present disclosure, the microspheres are sufficiently embedded into the surface of the sheet substrate, such that they are not easily removed from the surface of the sheet substrate.

The microspheres of the present disclosure are embedded into the sheet substrate using pressure and optionally heat. In one embodiment, the plurality of microspheres is placed on top of the sheet substrate and a platen or other smooth (e.g., flat) surface is placed onto the layer of microspheres and applies pressure, pushing the microspheres into the sheet substrate. In another embodiment, the substrate sheet may be placed on top of the plurality of microspheres, with optional weight placed on top of the substrate sheet, and gravity (or additional pressure) may be used to embed the plurality of microspheres into the substrate sheet. Heat is typically used to soften the sheet substrate to facilitate the embedding process however, pressing may be used by itself.

Depending on the substrate sheet and microspheres selected, and whether or not heat is applied, forces ranging from at least 1, 5, 10 or even 20 kN may be used; and at most 50, 100, 200 or even 500 kN may be used. For cold pressing, without the application of heat, pressures are used such that the substrate material passes through (or close to) its yield point. In one embodiment, pressures range from at least 20, 40, 60, 80, 100, or even 125 MPa; and at most 200, 225, 250, 275, 300, or even 350 MPa may be used.

Heat may be applied to soften the sheet substrate to facilitate the embedding process. Generally, the temperature employed is typically within a few degrees of the softening or melting temperature of the substrate. As used herein, the melting temperature refers to both the melting temperature, Tₘ, of a material, such as a metal and the glass softening temperature of glass. Typically for metals the temperatures are at least 60, 70, 80 or even 90% of melting temperature of the substrate. Typically, for glass and glass-ceramic substrates, the temperatures are at least 60, 70, 80, 90, 95, 99% of the Littleton softening temperature of the substrate. When hot pressing into a metal substrate, it may be advantageous to perform the embedding process in the absence of an oxidizing environment to facilitate adhesion of the microspheres to the substrate.

The combination of materials for the microsphere and the sheet substrate are selected such that the microspheres have a melting temperature higher than that of the sheet substrate. In one embodiment the melting temperature of the microspheres is greater than 10, 25, 50, 100, or even 150° C. than the melting temperature of the sheet substrate. By selecting such a combination, a durable coating for the sheet substrate can be provided.

In one embodiment, the melting temperature of the microspheres is close to the melting temperature of the sheet substrate. This results in necking of the microspheres as shown in FIG. 2, wherein microspheres 22 in bead-coated sheet 20 partially melt or soften causing the microspheres to coalesce and form a connection 26 between adjacent microspheres. However, in the present disclosure, the microspheres embedded in the sheet substrate still retain some angular curvature. Although not wanting to be bound by theory, it is believed that this angular curvature provides the low fiction properties of the bead-coated substrate's surface.

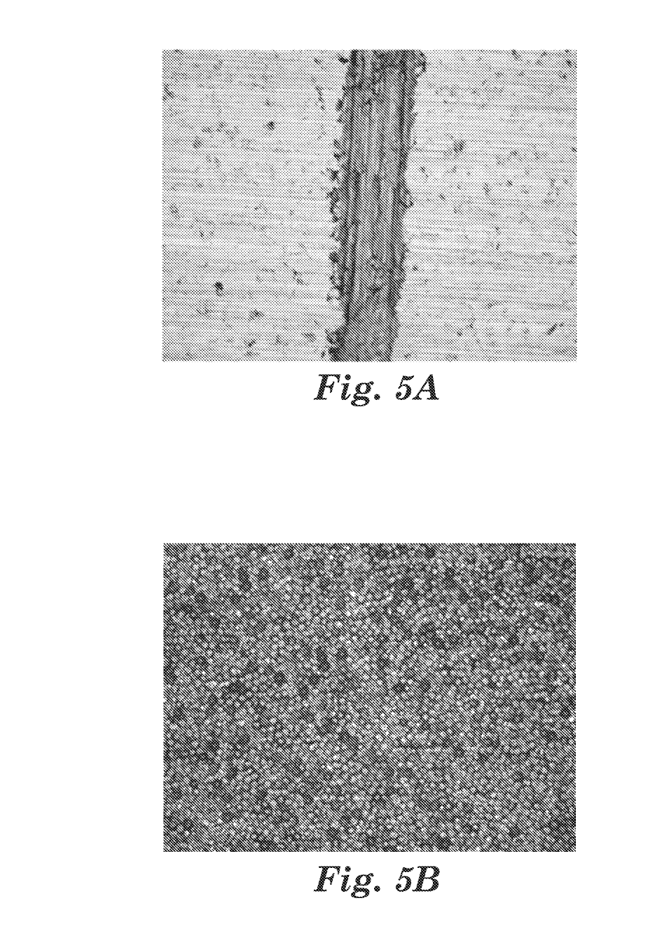

In one embodiment, it may be important to have smooth-to-the-touch surfaces. This can be achieved by among other things, ensuring that the difference in height of the apex of each of the embedded microspheres is within 5, 7, 10, 12, 15, or even 20 micrometers. See FIG. 4, which depicts microspheres 42 and 43 embedded into sheet substrate 44, where “d” represents the height difference of the apexes of microspheres 42 and 43. The lower the variation in height of the microsphere apexes, the more smooth the surface will feel to the touch.

The variation in peak height may be minimized by using a platen to apply pressure to the microspheres to facilitate their embedding into the sheet substrate. The platens should be rigid and smooth (e.g., flat) to enable uniform pressure applied to the sheet substrate to allow for even sinking. Because the platen is applying pressure, a polydistribution of microsphere sizes can be used in the present disclosure and still achieve smooth, low friction surfaces. Shown in FIG. 3 is platen 36 atop embedded microspheres 32 and 33, which are of different sizes.

The sheet substrate typically has a substantially planar surface to facilitate the embedding of the microspheres, however, it is not required that the sheet substrate be planar. The sheet substrate may have a curved or non-linear profile, which is matched by the profile of the platen (or pressing plate). Further, the resulting bead-coated sheet may be subsequently formed into a non-planar object, depending on the application.

The advantage of doing the process as described herein is that in one embodiment, the resulting bead-coated sheet is substantially free of a binder layer between the layer of microspheres and the sheet substrate. This may be advantageous if using in high temperature applications where low friction metal surfaces may be advantageous, for example in automobiles, gas turbine operations etc.

The bead-coated sheets of the present disclosure have durable, low friction, and/or smooth-to-the-touch surfaces.

In one embodiment, the resulting surface of the bead-coated sheet has a pencil hardness as measured by the Pencil Hardness Test, which is greater than the sheet substrate. Pencil Hardness can measure the durability of a surface. Such techniques are known in the art. Typically, pencils of varying hardness (high harness to low hardness) are passed along the surface of a material and the surface is examined by visually for scratches, rupture, etc. The hardest level of pencil that does not scratch, rupture, or dislodge microspheres from the surface is reported as the pencil hardness of the film.

In one embodiment, the resulting surface of the bead-coated sheet has a coefficient of friction of less than 0.6, 0.5 0.4, 0.3, or even 0.2 as tested by the Tactile Friction Test Method (below).

In one embodiment, the resulting surface of the bead-coated sheet has a coefficient of friction of less than 0.5 0.4, 0.3, 0.2 or even 0.1 as tested by a tribometer. In one embodiment, the resulting surface of the bead-coated sheet has a coefficient of friction of less than 0.5 0.4, 0.3, 0.2 or even 0.1 as tested by the Friction Test Method (below) with 100 cycles and a load of 1N.

Durable, low friction surfaces are commonly desired for a wide variety of consumer and industrial applications, such as industrial, consumer or medical tools and parts. The bead-coated sheets of the present disclosure may be used as durable cases for electronics, coatings for road markings, low friction orthodontic materials, low noise stethoscopes and even machine parts that operate at elevated temperatures and need low friction and good abrasion resistance.

A non-limiting list of exemplary embodiments and combinations of exemplary embodiments of the present disclosure are disclosed below:

### Embodiment 1

A bead-coated sheet comprising: a sheet substrate selected from at least one of: a metal, a glass, and a glass-ceramic; and a layer of microspheres, wherein the microspheres are partially embedded into a surface of the sheet substrate so that a portion of each of the microspheres projects outwardly from the surface of the sheet substrate, wherein (a) the average diameter of the microsphere is greater than 20 micrometers, (b) the microspheres are substantially spherical or (c) the average diameter of the microsphere is greater than 20 micrometers and the microspheres are substantially spherical.

### Embodiment 2

The bead-coated sheet of embodiment 1, wherein the surface of the bead-coated sheet has a coefficient of friction of less than 0.4.

### Embodiment 3

The bead-coated sheet of embodiment 1, wherein the apex of each of the microspheres embedded in the surface of the sheet substrate is less than 20 micrometers different in height.

### Embodiment 4

The bead-coated sheet of any one of the previous embodiments, wherein the bead-coated sheet is substantially free of a binder layer between the layer of microspheres and the sheet substrate.

### Embodiment 5

The bead-coated sheet of any one of the previous embodiments, wherein the layer of microspheres is a monolayer equivalent or less of microspheres.

### Embodiment 6

The bead-coated sheet of any one of the previous embodiments, wherein the sheet substrate has a thickness of at least 10 micrometers.

### Embodiment 7

The bead-coated sheet of any one of the previous embodiments, wherein the surface of the microsphere comprises at least one of: a metal, a metal oxide, a flux, a wetting layer, and combinations thereof.

### Embodiment 8

The bead-coated sheet of any one of the previous embodiments, wherein the microspheres have an average diameter of 25 to 1000 micrometers.

### Embodiment 9

The bead-coated sheet of any one of the previous embodiments, wherein the microspheres are selected from the group consisting of: glass, ceramic, glass-ceramic, metal, and combinations thereof.

### Embodiment 10

The bead-coated sheet of any one of the previous embodiments, wherein the microspheres are transparent, translucent, or opaque.

### Embodiment 11

The bead-coated sheet of any one of the previous embodiments, wherein the metal is selected from the group consisting of: aluminum, copper, tin, nickel, chrome, magnesium, titanium, iron, and alloys thereof, and combinations thereof, and stainless steel.

### Embodiment 12

The bead-coated sheet of any one of the previous embodiments, wherein 20 to 90% of the average diameter of each microsphere is embedded in the sheet substrate.

### Embodiment 13

The bead-coated sheet of any one of the previous embodiments, wherein the microspheres are necked together.

### Embodiment 14

The bead-coated sheet of any one of the previous embodiments, wherein the melting temperature of the microspheres is greater than the melting temperature of the sheet substrate.

### Embodiment 15

The bead-coated sheet of any one of the previous embodiments, wherein 90% of the surface of the sheet substrate is covered with microspheres.

### Embodiment 16

An article comprising the bead-coated sheet of any one of the previous embodiments.

### Embodiment 17

A method of making a bead-coated sheet comprising: providing microspheres, wherein (a) the average diameter of the microsphere is greater than 20 micrometers, (b) the microspheres are substantially spherical or (c) the average diameter of the microsphere is greater than 20 micrometers and the microspheres are substantially spherical; applying a layer of the microspheres onto a sheet substrate, wherein the sheet substrate is selected from the group consisting of: a metal, a glass, a glass-ceramic, and combinations thereof; and embedding the microspheres into the surface of the sheet substrate so that a portion of each of the microspheres projects outwardly from the surface of the sheet substrate.

### Embodiment 18

The method of embodiment 17, wherein the surface of the bead-coated sheet has a coefficient of friction of less than 0.4.

### Embodiment 19

The method of any one of embodiments 17-18, wherein heat and/or pressure is used to embed the microspheres into the surface of the sheet substrate.

### Embodiment 20

The method of embodiment 19, wherein a platen is used to embed the microspheres into the surface of the sheet substrate.

### Embodiment 21

The method of any one of embodiments 17-20, wherein the microspheres are selected from the group consisting of: glass, ceramic, glass-ceramic, metal, and combinations thereof.

### Embodiment 22

The method of any one of embodiments 17-21, wherein a liquid is applied to the surface of the sheet substrate prior to applying the layer of microspheres.

### Embodiment 23

The method of any one of embodiments 17-22, wherein the microspheres are applied to the surface of the sheet substrate as a mixture comprising the microspheres and a liquid.

### Embodiment 24

The method of any one of embodiments 22-23, further comprising removing the liquid during or after embedding the microspheres into the surface of the sheet substrate.

### Embodiment 25

The method of any one of embodiments 22-24, wherein the liquid is a solvent or a binder.

### Embodiment 26

The method of embodiment 25, wherein the solvent is oleic acid.

### Embodiment 27

The bead-coated sheet of any one of embodiments 1-15, wherein the surface of the bead-coated sheet has a coefficient of friction of less than 0.4 when measured using the Friction Test Method with 100 cycles and a load of 1N.

### Embodiment 28

The bead-coated sheet of any one of embodiments 1-15 and 27, wherein the pencil hardness of the resulting material has a pencil hardness as measured by the Pencil Hardness Test which is greater than the sheet substrate.

### Embodiment 29

The bead-coated sheet of any one of embodiments 1-15 and 27-28, wherein the surface of the bead-coated sheet has a coefficient of friction of less than 0.5 when measured using the Tactile Friction Test Method.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.

These abbreviations are used in the following examples: cm=centimeter, μm=micrometer, kN=kiloNewton, sec=second, and N=Newton.

### Test Methods

Before testing the samples were wiped with isopropanol.

### Friction Test

A tribometer (Standard Tribometer, obtained from CSM Instruments, Needham, Mass., USA) fitted with a stainless steel ball as the static partner was used. The samples were passed back and forth beneath the steel ball at rates varying between 0.05 cm/sec-0.4 cm/sec (1 cycle consisted of a forward pass followed by a backward pass) with a preset applied load and a stroke length of 0.4 cm. The lateral force on the stainless steel ball was monitored and recorded by the tribometer, for conversion to coefficient of friction (COF). Applied load and the number of cycles were varied and the samples were visually inspected under an optical microscope after testing. The COF was determined by dividing the lateral force on the steel ball during testing by the applied normal force.

### Tactile Friction Test

A ForceBoard (from Industrial Dynamics Sweden AB) was used to measure the tactile friction. This system uses multiple strain gauges to record normal and lateral forces applied to the sample.

The dynamic coefficient of friction (COF) is the unitless factor relating the normal force applied (by a finger in this case) to the lateral, or frictional, force of the finger as it is dragged along the surface. Described below is the method used for testing COF in the Tactile Friction Test. Since skin friction is highly dependent on the hydration level of the skin, it is important to compare COF values between samples under conditions where the hydration of the skin is consistent. Therefore, the following process includes steps for ensuring consistent hydration of the skin.

A test coupon of the material to be tested was attached to the surface of the force plate using repositionable adhesive.

The test subject's hands were washed using a mild detergent to remove any surface oils, and then dried using a paper towel. Then, the test subject's left index finger was immersed in a small amount of de-ionized water, with the water volume being enough to fully cover the area of the finger that will be in contact with the surface of the test coupon. After 20 seconds of soaking, the finger is removed from the water and the surface moisture is dried using an absorbent paper towel.

Then, the test subject's left index finger (at an angle of roughly 30 degrees from normal) was then dragged along the surface of the test coupon at a range of normal forces from roughly 0.5-10 Newtons, increasing in force as the finger passes along the surface. After each pass of the finger, the finger was immersed in the water, and dried as described above. This process of dragging the finger across the surface and soaking and wiping the finger was repeated approximately 4-6 times for each sample, with the normal and lateral force data being recorded for each pass.

The force data was then converted to COF data, and the range of COF values for the various normal forces was plotted. The multiple passes for each sample were plotted simultaneously to serve as a check on the consistency of the data.

### Pencil Hardness Method

The surface of the sample was evaluated for pencil hardness following a similar procedure as disclosed in ASTM D3363-05(2011)e2 “Standard Test Method for Film Hardness by Pencil Test”. Abrasive sandpaper (Grit No. 400) was adhered to a flat and smooth benchtop with double coated tape. Pencil leads (Totiens Drawing Leads with mechanical lead holder) were held at an angle of 90° to the abrasive paper and abraded until a flat, smooth, circular cross-section was achieved, free of chips or nicks on the edge of the lead. The force on the tip of the pencil was fixed at 7.5 N or in some cases less. The free-standing bead film was placed on a glass surface. Using a freshly prepared pencil lead for each test, the lead was pressed firmly against the film at a 45° angle and at the desired load (7.5 N) using an Elcometer 3086 Motorised Pencil Hardness Tester (obtained from Elcometer Incorporated, Rochester Hills, Mich.) and drawn across the test panel in the “forward” direction for a distance of at least ¼ inch. Three pencil tracks were made for each grade of lead hardness. Prior to inspection, crumbled lead was removed from the test area using a damp paper towel wetted with isopropyl alcohol. The film was inspected by eye for defects and under an optical microscope (50×-1000× magnification) for the first ⅛ to ¼ inch of each pencil track. Moving from harder leads to softer, the process was repeated down the hardness scale until a pencil was found that did not scratch the film or rupture it, or dislodge or partially dislodge any beads. At least two of three tracks at each lead hardness were required to meet these criteria in order to pass. The hardest level of lead that passed was reported as the pencil hardness of the film.

### Comparative Example A

An aluminum plate (5cm×5 cm×3 mm (2 in.×2 in.×3 mm obtained from Lawrence and Frederick Inc., 5005 alloy, Temper H34).

### Example 1

An aluminum plate (5 cm×5 cm×3 mm (2 in.×2 in.×3 mm)) was wiped with oleic acid and the excess was wiped off, leaving a thin layer of oleic acid on the surface of the aluminum plate. Then glass beads (soda lime silicate, 40-60 μm diameter in size, 96-98% roundness, obtained from Swarco Industries, Columbia Tenn.) were flood coated on the oleic acid-coated surface and the excess beads were tapped off.

The aluminum plate comprising the glass microspheres was then placed between two flat 2.5 inch diameter tungsten carbide disks and loaded into a modified hot press from Toshiba Machine (2068-3, Ooka, Numazu-shi, Shizuoka-ken 410-8510, Japan). The chamber was filled with nitrogen to remove oxygen and infrared lamps were used to heat the material. Pressure was applied during heating. When the press reached 645° C., 10 kN of force was applied and the displacement of the crosshead was monitored to control the degree of bead sink. Once the desired crosshead movement was obtained, the run was terminated and the sample was rapidly cooled to 50° C. with flowing nitrogen. The sample was then removed from the press.

The resulting sample had a surface that felt silky smooth to the touch and had a matte type appearance. Microscope images confirmed the presence of closely packed microspheres that were pressed into the substrate. Images indicate that the glass beads had undergone some melting/coalescing during pressing, as the process temperature was close to the melting temperature of the glass.

### Example 2

An aluminum plate (5 cm×5 cm×3 mm) was wiped with oleic acid and the excess was wiped off, leaving a thin layer of oleic acid on the surface of the aluminum plate. Glass-ceramic beads (25-40 μm in diameter, with a 2.42 refractive index, made by a melt process as per disclosure in U.S. Pat. No. 7,947,616 (Frey et al., Example 8)) were then flood coated on the oleic acid-coated surface and the excess beads were tapped off.

The aluminum plate comprising the glass ceramic microspheres was then placed between two flat 2.5 inch diameter tungsten carbide disks and loaded into a modified Toshiba Machine hot press. The chamber was filled with nitrogen to remove oxygen and infrared lamps were used to heat the material. When the press reached 645° C., 10 kN of force was applied and the displacement of the crosshead was monitored to control the degree of bead sink. Once the desired crosshead movement was obtained, the run was terminated and the sample was rapidly cooled to 50° C. The sample was then removed from the press.

The resulting sample had a surface that felt silky smooth to the touch and had a matte type appearance. Microscope images confirmed the presence of closely packed microspheres that were pressed into the substrate. Images indicate that there was no apparent melting or coalescing of the glass ceramic beads during the processing.

Comparative Example A and Examples 1-2 were tested using the Friction Test and Pencil Hardness Methods as described above. The results are shown in Table 1.

TABLE 1

| | Friction Test | | | | |
|---|---|---|---|---|---|
| | | | | Scratch severity | |
| | | | | on surface after | Pencil |
| Example | cycles | load | COF | Friction Test | Hardness |
| CE A | 10 | 1 N | 1.5 | High | 3B |
| 1 | 10 | 1 N | 0.2 | None | ~9H |
| | 100 | 1 N | 0.97 | Mild | |
| | 1000 | 1 N | 0.99 | High | |
| 2 | 100 | 1 N | 0.19 | None | ~9H |
| | 200 | 1 N | 0.14 | None | |
| | 800 | 1 N | 0.18 | None | |
| | 80 | 10 N | 0.16 | Mild | |

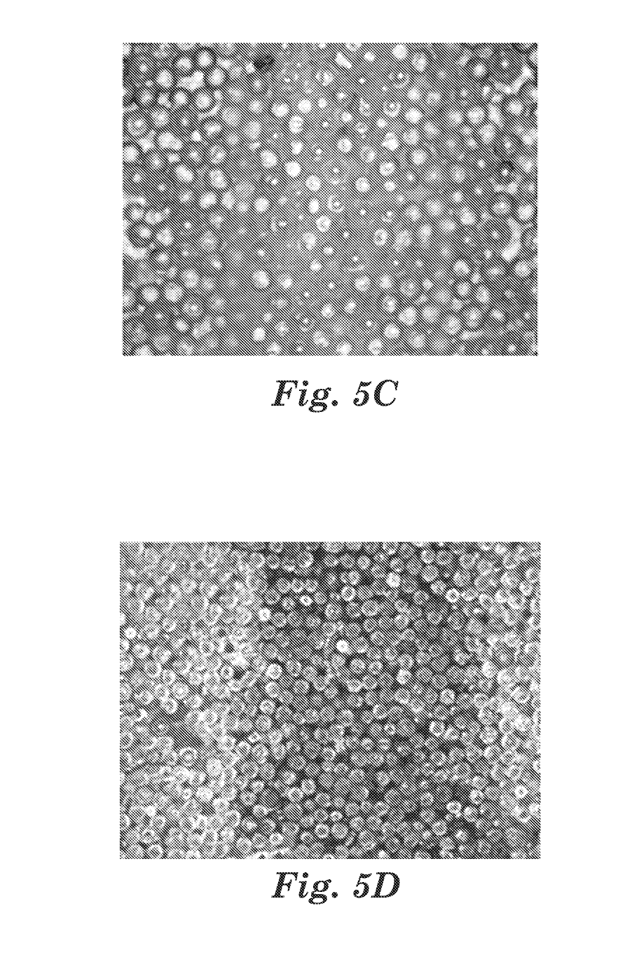

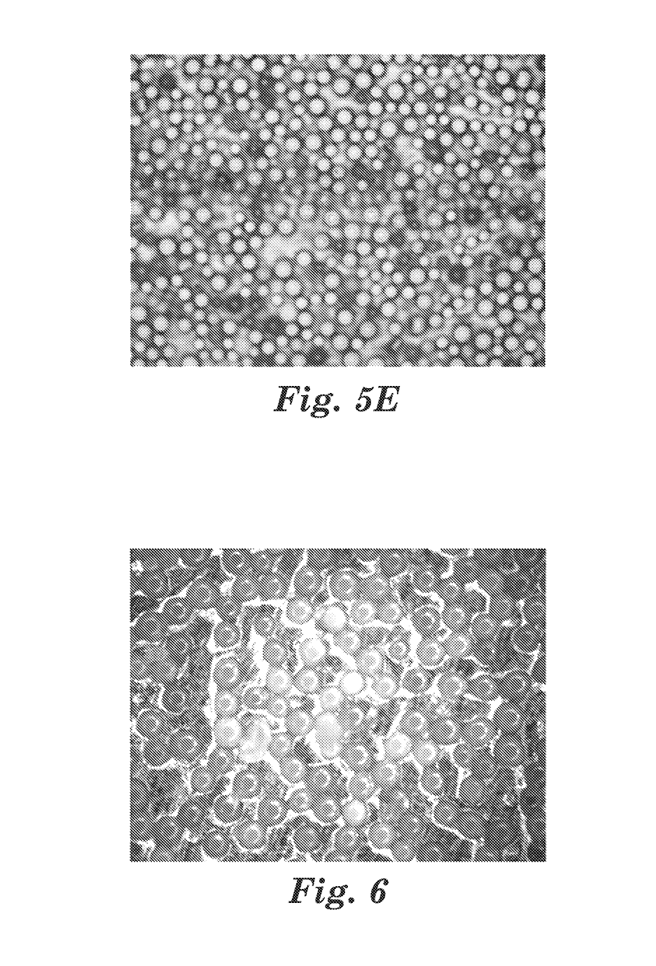

FIG. 5A is an optical micrograph of the surface of CE-A after it has been subjected to the Friction Test at an applied load of 1N and 100 cycles. FIG. 5B is an optical micrograph of the surface of Example 1 before the Friction Test. FIG. 5C is an optical micrograph of the surface of Example 1 after it has been subjected to the Friction Test at an applied load of 1N and 1000 cycles. FIG. 5D is an optical micrograph of the surface of Example 1 after it has been subjected to the Pencil Hardness Test at 6H. FIG. 5E is an optical micrograph of the surface of Example 2 after it has been subjected to the Friction Test at an applied load of 1N and 800 cycles.

### Example 3

An aluminum plate (5 cm×5 cm×3 mm) was wiped with oleic acid and the excess was wiped off, leaving a thin layer of oleic acid on the surface of the aluminum plate. Glass beads (soda lime silicate, 40-60 μm diameter in size, 96-98% roundness, obtained from Swarco Industries) were flood coated on the oleic acid-coated surface and the excess beads were tapped off.

The aluminum plate comprising the microspheres was then placed into a hydraulic uniaxial press (obtained from Carver, Inc., Summitt, N.J.) fitted with a 3.81 cm stainless steel die. A WC flat plate was placed under the aluminum substrate to keep the sample from bending and a load of 35.59 kN was applied. After pressing the surface of the bead embedded sheet was viewed under a microscope. FIG. 6 is an optical micrograph of the surface of Example 3. The beads were embedded in the metal surface with a bead sink around 50% and the sample had a silky smooth feel.

### Comparative Example B

A tin plate substrate (5 cm×5 cm×3mm) obtained from McMaster Carr Industries, Elmhurst Ill.

### Example 4

A tin plate substrate as used in Comparative Example B was pressed with glass beads (soda lime silicate, 40-60 μm diameter in size, 96-98% roundness, obtained from Swarco Industries, Columbia Tenn.) using a uniaxial Carver press and 57.8 kN pressure, using the preparation and pressing procedure described in Example 3.

### Comparative Example C

A copper plate substrate (5 cm×5 cm×3 mm) obtained from McMaster Carr.

### Example 5

A copper plate substrate as used in Comparative Example C was wiped with oleic acid and the excess was wiped off, leaving a thin layer of oleic acid on the surface of the copper plate. Then with glass-ceramic beads (average diameter 38-75 micrometers, comprising 45 wt % La₂O₃, 20 wt % Al₂O₃, 30 wt % ZrO₂, and 5 wt % TiO₂ which can be made following the disclosure in U.S. Pat. No. 7,563,293 (Rosenflanz)) were flood coated on the oleic acid-coated surface and the excess beads were tapped off.

The copper plate comprising the glass-ceramic microspheres was then placed between two flat 2.5 inch diameter tungsten carbide disks and loaded into a modified hot press from Toshiba Machine. The chamber was filled with nitrogen to remove oxygen and infrared lamps were used to heat the material. Pressure was applied during heating. When the press reached 800° C., 50 kN of force was applied for 15 minutes. Once the desired crosshead movement was obtained, the run was terminated and the sample was rapidly cooled to 50° C. with flowing nitrogen. The sample was then removed from the press.

Comparative Examples B and C and Examples 4 and 5 were tested using the Friction Test. The results are shown in Table 2

TABLE 2

Friction Test

| | | | | Scratch severity |
|---|---|---|---|---|
| | | | | on surface after |
| Example | cycles | load | COF | Friction Test |
| C. Ex B | 1 | 1 N | 0.27 | None |
| | 50 | 1 N | 1.16 | High |
| | 100 | 1 N | 1.6 | High |
| C. Ex C | 1 | 5 N | 0.21 | None |
| | 50 | 5 N | 0.74 | High |
| | 100 | 5 N | 0.78 | High |
| 4 | 1 | 1 N | 0.15 | None |
| | 50 | 1 N | 0.12 | None |
| | 100 | 1 N | 0.16 | None |
| 5 | 1 | 5 N | 0.25 | None |
| | 50 | 5 N | 0.30 | None |
| | 100 | 5 N | 0.34 | None |

### Comparative Example D

An aluminum plate substrate as used in Comparative Example A was pressed with E-glass powder particles (irregular shaped particles (200-400 mesh) from Vitro Minerals, Conyers, Ga.) using the preparation and pressing procedure described in Example 1 except that the particles were pressed at 650° C. with 98 kN of pressure for 15 minutes. Pressed samples showed a rough feel, very different from samples that had microsphere beads pressed in to them.

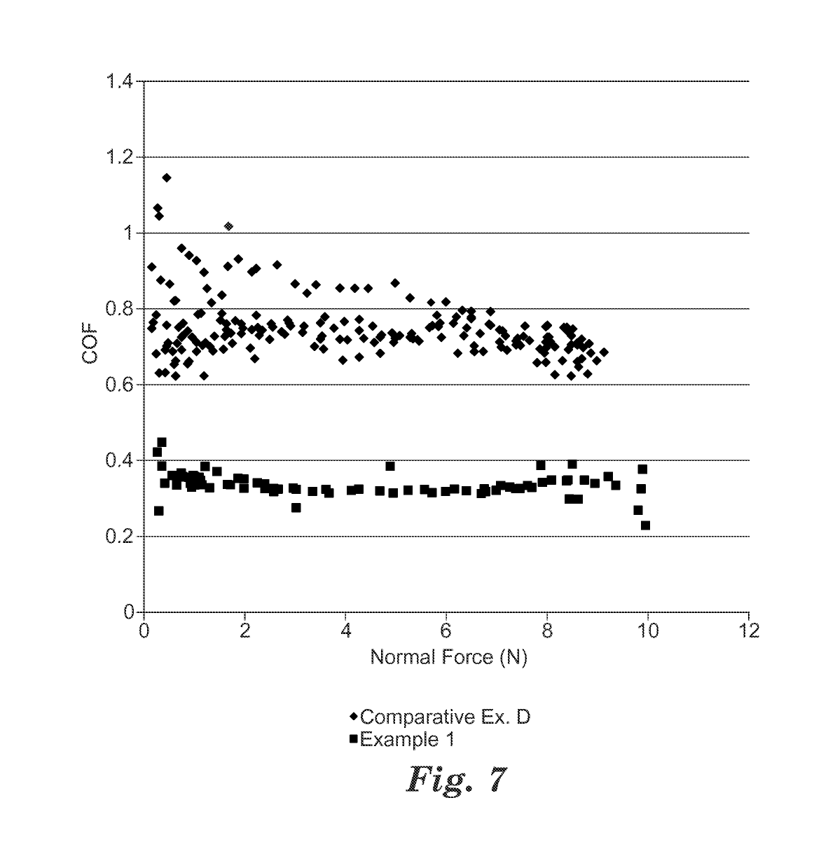

Example 1 and Comparative Example D were tested using the Tactile Friction Test above and the results are shown in FIG. 7. Measurements show that the glass powder particles pressed into the aluminum substrate results in a higher COF compared to Example 1, which used substantially rounded microspheres.

### Example 6 and Comparative Example E

A soda-lime silicate glass plate (6 cm×4 cm×5 mm) was placed on top of a collection of glass-ceramic beads (20-80 μm in diameter, with a 2.42 refractive index, made by a melt process as per disclosure in U.S. Pat. No. 7,947,616 (Frey et al., Example 8)) contained in an alumina crucible. The alumina crucible comprising the glass ceramic microspheres with a plate of a soda-lime glass lying on top of the microspheres was then placed in a furnace and heated to 800° C. at 10° C./min heating rate, followed by an isothermal treatment at 800° C. for 30 min.

The furnace was cooled and the glass plate was removed from the furnace. It was observed that the glass-ceramic beads were embedded in the glass plate on the side which was in direct contact with beads. The other side of the plate remained clear from beads.

The beaded side of the soda lime silicate plate (Example 6) and the non beaded back side of the plate (Comparative Example E) were tested using the Friction Test. The results are shown in Table 3.

Friction Test

| | | | | Scratch severity |
|---|---|---|---|---|
| | | | | on surface after |
| Example | cycles | load | COF | Friction Test |
| C. Ex E | 1 | 1 N | 0.16 | None |
| | 50 | 1 N | 0.98 | High |
| | 50 | 5 N | 0.85 | High |
| Ex. 6 | 1 | 1 N | 0.17 | None |
| | 50 | 1 N | 0.17 | None |
| | 50 | 5 N | 0.52 | Mild |

Foreseeable modifications and alterations of this invention will be apparent to those skilled in the art without departing from the scope and spirit of this invention. This invention should not be restricted to the embodiments that are set forth in this application for illustrative purposes.

1. A bead-coated sheet comprising:
a sheet substrate selected from at least one of: a metal, a glass, and a glass-ceramic; and
a layer of microspheres, wherein the microspheres are partially embedded into a surface of the sheet substrate so that a portion of each of the microspheres projects outwardly from the surface of the sheet substrate, wherein the microspheres are substantially spherical and wherein the surface of the bead-coated sheet has a coefficient of friction of less than 0.4 when measured using the Friction Test Method with 100 cycles and a load of 1N.

2. (canceled)

3. The bead-coated sheet of claim 1, wherein the pencil hardness of the resulting material has a pencil hardness as measured by the Pencil Hardness Test which is greater than the sheet substrate.

4. The bead-coated sheet of claim 1, wherein the surface of the bead-coated sheet has a coefficient of friction of less than 0.5 when measured using the Tactile Friction Test Method.

5. The bead-coated sheet of claim 1, wherein the apex of each of the microspheres embedded in the surface of the sheet substrate is less than 20 micrometers different in height.

6. The bead-coated sheet of claim 1, wherein the bead-coated sheet is substantially free of a binder layer between the layer of microspheres and the sheet substrate.

7. The bead-coated sheet of claim 1, wherein the microspheres are necked together.

8. An article comprising the bead-coated sheet of claim 1.

9. A method of making a bead-coated sheet comprising:
providing microspheres, wherein the microspheres are substantially spherical;
applying a layer of the microspheres onto a sheet substrate, wherein the sheet substrate is selected from the group consisting of: a metal, a glass, a glass-ceramic, and combinations thereof; and
embedding the microspheres into the surface of the sheet substrate so that a portion of each of the microspheres projects outwardly from the surface of the sheet substrate and wherein the surface of the bead-coated sheet has a coefficient of friction of less than 0.4 when measured using the Friction Test Method with 100 cycles and a load of 1N.

10. The method of claim 9, wherein a platen is used to embed the microspheres into the surface of the sheet substrate.

11. The method of claim 9, wherein a liquid is applied to the surface of the sheet substrate prior to applying the layer of microspheres.

12. The bead-coated sheet of claim 1, wherein the average diameter of the microsphere is greater than 20 micrometers.

13. The bead-coated sheet of claim 1, wherein the average diameter of the microsphere is 25 to 1000 micrometers.

14. The bead-coated sheet of claim 1, wherein the microsphere is translucent or opaque.

15. The bead-coated sheet of claim 1, wherein the sheet substrate has a thickness of at least 10 micrometers.

16. The bead-coated sheet of claim 1, wherein 20 to 90% of the average diameter of each microsphere is embedded in the sheet substrate.

17. The method of claim 11, wherein the liquid is oleic acid.

18. The method of claim 11, further comprising removing the liquid during or after embedding the microspheres into the surface of the sheet substrate.

19. The method of claim 9, wherein the average diameter of the microsphere is greater than 20 micrometers.

20. The method of claim 9, wherein pressure is used to embed the microspheres into the surface of the sheet substrate.
